(19) United States
(12) Patent Application Publication
(10) Pub. No.: US 2015/0073909 A1
(43) Pub. Date: Mar. 12, 2015

(54) Systems and Methods for Automatic Creation, Optimization, Targeting, and Delivery of Real-Time Advertising

(71) Applicants: Jeffrey Peden, Boston, MA (US); Jeff Christoforetti, Cambridge, MA (US)

(72) Inventors: Jeffrey Peden, Boston, MA (US); Jeff Christoforetti, Cambridge, MA (US)

(73) Assignee: CraveLabs, Inc., Boston, MA (US)

(21) Appl. No.: 14/481,869

(22) Filed: Sep. 9, 2014

Related U.S. Application Data
(60) Provisional application No. 61/875,610, filed on Sep. 9, 2013.

(51) Int. Cl. G06Q 30/02; G06Q 30/04

(52) U.S. Cl. CPC G06Q 30/0276; G06Q 30/0261; G06Q 30/0267; G06Q 30/0275; G06Q 30/04
USPC 705/14.58

(57) ABSTRACT

Disclosed herein are systems and methods for real-time creation of advertising based, in part, on a user's viewing of content. The disclosed systems and methods further relate to the optimization and targeting of advertising to consumers. Furthermore, the systems and methods relate to businesses automatically bidding for generated advertising content.

### FIELD

This disclosure relates generally to systems and methods for advertising and tracking consumer activity.

### BACKGROUND

The proliferation of usage by modern consumers of mobile devices capable of internet access and application usage, such as smart-phones and tablet computers, has caused a shift in patterns of when, where, and how such consumers access information and content. A majority of consumers with these devices now primarily access information on news, sports, entertainment, events, local listings and directions, email, and interact with social networking applications and games from mobile devices.

The advent of 3G and 4G data networks, and near ubiquitous availability of wireless LAN (WiFi) networks has aided in this trend of adoption and usage, and enabled more content to be delivered to mobile devices over wireless data networks. The commoditization of advanced hardware features such as high-resolution touchscreens, high resolution cameras, and onboard sensing systems for touchscreen gesture, motion control, near-field communications, Bluetooth device interaction, and GPS or WiFi-assisted location determination have enabled applications on mobile devices to combine these capabilities with always-on (or nearly always-on) internet access to produce new types of rich user experiences. Further, advances in mobile web-browser standards and APIs have enabled many of these features to also be accessible to web-based Internet applications delivered through a browser.

With consumer usage trending towards spending a significant portion of their total media consumption time on such mobile devices, it has become imperative for businesses to reach consumers with messages and advertising, and shift advertising spending from other forms of media such as print, TV, radio, and standard online ads to forms of media advertising that reach the consumer on their mobile internet devices. Due to limited screen real-estate compared to other forms of media, the importance of delivering advertising to the right consumers with the right message, at the right time and place, and with a call-to-action that triggers a desired behavior by the consumer is critical, since the ability to more widely deliver un-targeted broadcast forms of advertising is restricted by the limited availability of advertising impressions and viewing time of each impression in this form of media.

Further, the rapid adoption by consumers over the past several years of real-time forms of social media networking applications, such as Facebook, Twitter, and Foursquare, have driven businesses to adopt an online presence on these social media sites. These social media networks allow businesses to deliver a message, including digital photography or other images or video, hypertext links to sites and applications, and other forms of rich content, to a limited audience of consumers who have chosen to “follow” (subscribe to messages) the business. These messages are commonly delivered in real-time or near-real-time to consumers, as the consumers interact with the social media applications or websites. Often, the number of consumers who may elect to subscribe to a business' communications through one of their social media presences is a small fraction (0.1%-10%) of the total audience that the business would otherwise wish to desire to reach. Further, due to the nature of asynchronous posting of messages by a business and a consumers viewing of their social media subscriptions (e.g. via a “newsfeed” or other similar mechanism), a reduced percentage (5%-20%) of followers will see any given message posted by the business. Therefore, present technologies do not allow advertisers or businesses to efficiently target their advertising campaigns to consumers.

### SUMMARY

Disclosed herein are systems and methods of automatic creation, optimization, targeting and delivery of social-media integrated real-time mobile advertising. Such systems allow for planning and producing mobile advertising units, as well as executing complete mobile advertising campaigns to deliver new advertisements in real-time to a targeted audience of consumers. The disclosed systems reduce the resources needed by an advertiser in the form of expertise, time, and total cost when advertisements are planned, created, executed, delivered, and analyzed.

The systems and methods disclosed herein allow for, in part, planning and producing mobile advertising units and executing complete mobile advertising campaigns to deliver new advertisements in real-time to a targeted audience of consumers. The disclosed systems and methods leverage automation technology to reduce the resources needed by an advertiser in the form of expertise, time, and total cost. Furthermore, the disclosed systems and methods allow for automatically repurposing data and materials in order to more efficiently create and execute mobile advertising campaigns.

In certain embodiments, the systems described herein automatically repurpose data and materials that are outcomes of those efforts in order to more efficiently create and execute mobile advertising campaigns. In particular embodiments, the systems comprise multiple components that facilitate each of the different facets of running a mobile campaign: creative, planning, delivery, and analytics.

Aspects of the disclosed systems comprise subsystems to cache advertising content and deliver content to a user. In certain embodiments, the systems comprise a computing server system architecture. In particular embodiments, the server system architecture is an autoscaling clustered server system.

Aspects of the disclosed systems further comprise a bidding subsystem. In certain embodiments, the bidding subsystem comprises a real-time bidding protocol adapter and a bidding and pricing engine. In other embodiments, the disclosed systems further comprise an insertion order management subsystem. In particular embodiments, the insertion order management subsystem comprises code to enable direct billing of Advertisers via Credit Card or other payment.

Aspects of the disclosed systems further comprise a database storage subsystem. In some embodiments, the database storage subsystem is on a server or computer. In other embodiments, the disclosed systems comprise an audience analysis subsystem. In some embodiments, the disclosed systems comprise a campaign optimization subsystem. In other embodiments, the disclosed systems comprise a geotargeting subsystem.

Aspects of the disclosed systems further comprise an ad serving subsystem. In certain embodiments, the ad serving subsystem comprises ad rendering engine and HTML/Rich media rendering engine. In other embodiments, the disclosed systems further comprise a web rendering subsystem. In some embodiments, the disclosed systems further comprise social networking integration points. In further embodiments, the disclosed systems further comprise performance analytics subsystem. In some embodiments, the disclosed systems further comprise an asset aggregation subsystem. In particular embodiments, the disclosed systems further comprise a content subscription and monitoring engine.

### BRIEF DESCRIPTION OF THE FIGURES

FIG. 1 is a schematic of an embodiment of the disclosed systems.

FIG. 2 is a flowchart showing how an advertisement is rendered to a user upon user request to view content on a mobile device.

FIG. 3 is a representation of a heat map showing the distribution of ad unit impressions viewed by consumers in a region.

### DETAILED DESCRIPTION

### 1. Systems for Real-Time Advertising

Disclosed herein are systems that allow for real-time creation of advertising when a user accesses content on a website or through an application. In certain embodiments, the user requests content using a mobile device such as a cellphone, tablet, or other mobile device. In some embodiments, the user requests content through an application (herein referred to as an “app”) on a mobile device. In more particular embodiments, the user requests content through apps on social-media websites such as Facebook, LinkedIn, or any other social-media platform that allows users to access content.

The disclosed systems further allow for the optimization and targeting of advertising in real-time. In certain embodiments, the optimization comprises creating ad copy that takes into account the users past online activities, geographic location, and content viewing behavior. The disclosed systems further deliver the advertising that has been created by the system.

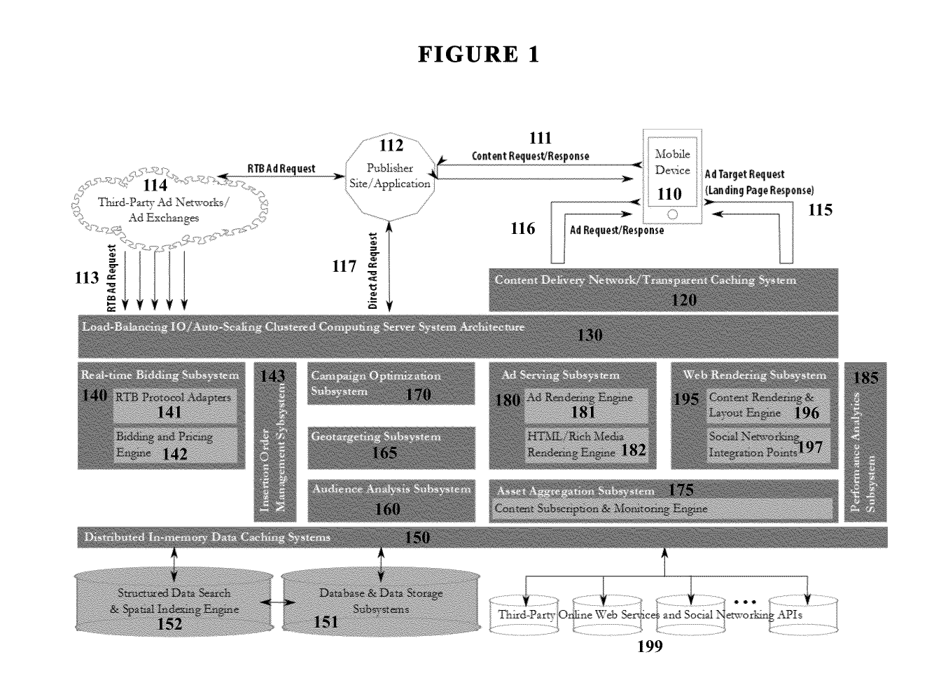

An illustrative embodiment of the disclosed systems is shown in FIG. 1. The mobile device 110 (“a user”) makes a content request 111. In this embodiment, the content request 111 is made through an application and is also sent to the Publisher Site 112 and to the system through the Content Delivery Network/Transparent Caching System 120. This Transparent Caching System 120 stores popular advertising content and also delivers created content from the system to the mobile device 110.

The Publisher Site 112 makes a Real-Time Bid (“RTB”) ad request 113 (“Ad Request” or “Bid Request”) to third-party ad networks and ad exchanges 114. The ad requests 113 to the third-party exchanges and networks 114 are identified by the Auto-Scaling Clustered Computing Server System Architecture 130. In some embodiments, the Publisher Site 112 makes a direct advertising request 117 to the system. As disclosed herein, the disclosed systems use multiple techniques and server systems to enable the high throughput and low latency required to act as described above during periods where Bid Requests are occurring at a high rate of concurrency.

In certain embodiments, the disclosed systems use multiple techniques and server systems to enable the high throughput and low latency required to act as described above during periods where Bid Requests are occurring at a high rate of concurrency. As shown in FIG. 1, the system comprises a Real-Time Bidding Subsystem 140. The RTB Subsystem 140 and associated system components can be replicated across one or more Server Instances (not shown), in the form of either Virtual Machine instances or physical hardware systems. In FIG. 1, these Server Instances are connected via various combinations of physical or virtual networking technologies. The RTB Engine 140 components share access to a common central Database Server (or Servers) that contains a master storage record of the RTB Engine data and activity. Each of these RTB Engine Server Instances can typically handle thousands of Bid Request/Response operations per second.

In FIG. 1, each of the RTB Engine Instances employs an in-memory cache of data from the database that is likely to be accessed, as determined by frequency of use, pre-fetching, or most-recently used queries to the Database Server. In certain embodiments, the in-memory cache is used to reduce the load placed on the central Database Server. In addition, the system shown in FIG. 1 comprises a shared second-layer Cache Server or Cache Servers may be employed. These servers are designed specifically to coordinate caching information across a distributed network of application servers, such as the RTB Engine 140. As one RTB Engine 140 updates information in the database, the information is transparently cached both locally, and, in some embodiments, in Cache Servers. In certain embodiments, the Cache Servers further distribute this information between themselves. As another RTB Engine Instance requests this information, an updated version is already loaded in memory in a Cache Server, providing faster access and reducing load on the Database Server. Additionally, updates may send an invalidation message to other RTB Engine Instances to notify the 1st and 2nd level Caches that the data they contain is considered dirty, and a fresh copy should be retrieved from the Database.

Further, the index is replicated in near-real-time across each of the Servers because the separate search indexing systems are frequently updated and accessed across multiple RTB Engine Servers. Replicating the index is advantageous when the separate search indexing systems are frequently updated and accessed across multiple RTB Engine Server instances. In some embodiments, the system utilizes a distributed data-grid distribution system to replicate the index, providing a consistent version of the index across all Instances. Updates to the index may be pushed from any given Server Instance to a dynamically elected Master Index Instance to perform the modifications, and then replicated back to the other Server Instances, in order to reduce lock contention during concurrent modifications. The Indexes can be replicated in part, or in whole, across one or more servers in the data-grid, in a fashion such that each part is available on at least two servers at any given time. Further, part or all of a given Index can be passivated to a permanent storage system, which in some embodiments is designated to provide storage in the Database Server as a permanent backing store for the Indexes.

In certain embodiments, the third party Ad Network 114 is configured with a single Endpoint address for each Bidder. In some embodiments, the disclosed systems use a Transparent Load-Balancing HTTP Server configuration to handle each inbound Bid Request 113 and deliver it to one of the active RTB Engine Server Instances transparently. In particular embodiments, neither the third Party Ad Network nor the RTB Engine Server Instance know specifically about the Load-Balancer, and are able to operate as if there is a one-to-one communications channel in place.

In some embodiments, the system utilizes an autoscaling coordination system to monitor the load and volume of requests in real-time, and start or stop Server Instances based upon a configured set of autoscaling rules. One advantage to utilizing an autoscaling coordination system is to allow dynamic scale up and down over time to handle a greater volume of requests or to conserve resources and reduce costs.

In particular embodiments, the system comprises multiple Server Instances. In FIG. 1, as each Server Instance starts or stops, it informs each of the other Server Instances of its activity, pre-loads any necessary Cache or Data-Grid information, and registers with the Load-Balancer to begin receiving requests. In some embodiments, the system utilizes a system of Servers and software programs that enable this to occur automatically, without Administrative User intervention in the process.

As disclosed herein, when a user of an app or website is actively viewing content on said application or site, a request 111 is made to a Publisher Site 112 over a data network (e.g., wireless data network). As the content is being rendered and returned to the mobile device 110, the Publisher's ad server will send a request for an Ad Unit Impression to be served to one or more Advertising Networks 114. These Advertising Networks 114 will communicate, in real-time, to one or more Bidders registered with the network, by sending a network command known as a Bid Request 113.

Such Bid Requests 113 are processed by the Real-Time Bidding Subsystem 140 (FIG. 1). These Bid Requests 113 may be sent via protocols such as OpenRTB or other proprietary encodings (RTB protocol) and are processed by the RTB Protocol Adaptors 141 of the Real-Time Bidding Subsystem 140 (FIG. 1). Bid Requests 113 may contain data including requested Ad Unit size and type, the classification of the site or application requesting the data, information on the device requesting the content (such as device type, location, operating system, device identification and IP address), or information on the user (such as registration zip code, gender, age, or interests). The Bid Request 113 may further be augmented with additional proprietary data known about the user by combining first-party data from the publisher with third-party data that has been linked to known data based on the user (such as household income, other applications commonly used, etc.).

The Bidder must receive this request, and determine whether or not to bid on delivering an Ad Unit to the mobile device in a finite amount of time before the Ad Network 114 determines that the request has timed out (typically 100 ms or less). If the Bidder determines that a No-Bid is applicable, it may return a simple response to the request via the RTB protocol identifying that it will not bid. If the Bidder determines that it would like to participate in the Auction for a Bid Request, it must return a Bid Response containing the price it is willing to pay to purchase the available Ad Unit Impression, information on the Advertiser the Bid Response is applicable to, and a Creative Specification for the Ad Unit to be delivered for the Impression in question.

In some embodiments, the Bidder system typically handles between 1,000 and 100,000 Bid Requests per second, and returns a majority of responses (typically >99%) in under the 100 ms Timeout period.

Aspects of the disclosed systems further comprise an Audience Analysis Subsystem 160 (FIG. 1). The Audience Analysis Subsystem/Engine 160 performs an ETL process on subscription and/or follower audience profiles that the advertiser has aggregated via social media networks or other 3rd party data collection systems. The Audience Analysis Engine 160 extracts geographic and demographic data about an advertiser's existing engaged consumer base, and transforms that data into a targeting profile that enables the RTB engine to bid for mobile ad impressions when a new consumer that matches the profile.

In some embodiments, the system shown in FIG. 1 further comprises a Geospatial Subsystem 165. The Geospatial Subsystem 165 provides other system components with information about physical locations and regions, including position, bounds, neighboring areas, neighborhood/city/county/state/country/continent, or other geographic attributes. In particular embodiments, the Geospatial Subsystem 165 can compute distances between two points on Earth, or between points and areas, or determine if a point is within a given distance range of another point. In particular embodiments, the location of a mobile device is cataloged by a Geohash reference. A Geohash is a character encoded string that uniquely identifies a position on the Earth and can be used as a spatial reference to a point or area on earth. The system is able to transform between geohash strings and spatial coordinate pairs at varying levels of precision according to one or more algorithms which are known to those familiar with the state of the art in geospatial encoding.

Returning to the Audience Analysis Engine 160, the Audience Analysis Engine 160 combines the extracted data from the Advertiser's existing profile with a time-window sampled history of prior bid requests to predict the future availability of matching bid requests in a desired geographic area. The Audience Analysis Engine 160 may employ Kernel Density Estimation or other multivariate statistical probability algorithms to predict the future probability of sufficiently meeting demand for a requested amount of available advertising impressions. The Audience Analysis Engine 160 further applies these prediction algorithms across multiple geospatial areas (zip code, circle defined by latitude/longitude and radius, or polygon defined by multiple latitude/longitude pairs) ordered in precedence by physical proximity or distance from desired target areas output by the ETL process.

The Audience Analysis Engine 160 can then create a union set of geospatial areas that best satisfy a) resemblance to existing consumer subscription/follower data, and b) probability of matching more consumers in or near the desired target areas that will find the advertiser's message relevant. In particular embodiments, the Audience Analysis Engine 160 further refines this model with additional input from the Advertiser (such as additional target geospatial areas), or over time automatically performs periodic or continuous input and run ETL processes on changing Advertiser subscription/follower data.

In some embodiments, the Audience Analysis Engine 160 further employs Hidden Markov Model-type algorithms to determine future probabilities of a future match that may occur without direct knowledge of the cause. In other embodiments, the engine infers that changes in weather or time of day/month/year may have an impact on availability of impressions. In still other embodiments, the changes include popularity of mobile applications and websites, age and gender distributions across available bid requests, or short-term social media spikes and long-term trends.

In FIG. 1, the Audience Analysis Engine 160 employs the use of external data sources to assign relative values and scoring to each geospatial target area (such as census data for household income). By applying this ranking and scoring of spatial areas in conjunction with proximity and predicted availability data, the engine can output a list of target areas to be used by the RTB Engine 140 in determining if and when to bid, and how much to bid, on any given impression bid request, in real-time.

The system of FIG. 1 also comprises Campaign Optimization Subsystem 170 (FIG. 1). The Campaign Optimization Subsystem 170 monitors Ad Unit delivery performance, and can alter future attributes of an Ad Unit Campaign by looking at recent performance and applying algorithms to determine if certain variations (such as Ad Unit size, color, layout) or alternate Campaigns (using other Ad Unit Assets such as text and photo) perform better than other variations. In certain embodiments, the Campaign Optimization Subsystem 170 may look at the performance of external campaigns, such as Social Media posts, and use third-party performance data to inform the algorithms on likely future performance.

Furthermore, aspects of the disclosed systems comprise an Asset Aggregation and Creative Generation Subsystem 175 (FIG. 1). The Asset Aggregation and Creative Generation Subsystem 175 performs an Extract/Transform/Load (or ETL) process on external data inputs for conversion into a graphically rendered Ad Unit asset that is suitable for distribution via mobile advertising networks. In one embodiment, the system starts with the aggregation of creative assets from one or more online or social media presences owned or operated by the advertiser. The Asset Aggregation Subsystem 175 continuously monitors each of registered online or social media properties for messages posted (“Posts”) by or on behalf of the advertiser. When detected, these Posts and any related photos, images, text, videos, or links are collected by the Asset Aggregation Subsystem 175, and recorded in a database. In some cases, the data recorded is limited to a unique ID code or identification URL from which the assets can be later collected.

In certain embodiments, requests are made to the Ad Serving Subsystem 180 as soon as the existence of new assets suitable for a campaign have been detected by the system (FIG. 1). When a request is made to retrieve the ad unit by a client, typically via HTTP protocol, the Ad Rendering Server (not shown) retrieves the required assets and passes them to the Ad Rendering Engine 181, which automatically produces a graphic image suitable for use as a mobile advertising banner graphic. The Ad Rendering Engine 181 performs layout and composition of any included graphics, text, or other material to produce a single mobile advertising unit, typically in the form of a PNG or GIF formatted graphics file. Any required assets, if not already fetched by the Asset Aggregation Subsystem 175, can be retrieved, using HTTP or other network protocols. If the mobile ad unit has previously been requested, a cached version of the ad unit may be delivered to improve performance.

In certain embodiments, the Ad Rendering Engine 181 employs algorithms to automatically select optimal color palette choices for the background color of the rendered image, the foreground color of various rendered text elements, or stylistic attributes such as drop shadows. In some embodiments, the Ad Rendering Engine 181 employs a statistical sampling of the associated image that is part of the collection of Assets in order to determine the dominant color of the image, and convert that color into an HSL or similar color-space, in order to further determine an optimal complementary color of Ad Unit background and text. Based upon the chosen color for the banner background, further color-space transformations may be employed to ensure that the text colors used for rendering have a sufficient level of contrast from the background to be easily readable. Further, the colors chosen by the Renderer may utilize data about the User being shown the ad, such as Device type or User gender, or look at past performance of User engagement of Ad Units served, in order to determine an optimal color palette. In other embodiments, the systems further comprise web rendering subsystem 195 for the rendering of web content. The Web Rendering Subsystem 195 comprises a Content Rendering and Layout Engine 196 and Social Networking Integration Points 197 to provide web content to the mobile device 110.

In the event that additional information about the user and/or device, such as current location, are known at the time of Ad Serving (whether by information passed directly from the Publisher Site, contained in an RTB Bid Request 113, or determined via other method), this information may be used to dynamically render an ad containing information specific to the user viewing the Ad Unit.

The systems disclosed in FIG. 1 comprise an Ad Rendering Server (not shown) that has a HTML/Rich Media Rendering Engine 182 (FIG. 1). The Rich Media Engine 182 dynamically creates and serves a mobile ad unit in a rich media form, which is composed of HTML, Javascript, CSS, and image, video, font, or other files, and is rendered by the client in a web browser or container. These rich media units may or may not communicate with the mobile device's host browser or web container through Javascript or other APIs (such as MRAID).

In certain aspects, the disclosed systems comprise a Performance Analytics Subsystem 185 (FIG. 1). When a Bid Request 114 enters the RTB Engine, its lifecycle is tracked from stage to stage through: (1) Initial receipt of Request; (2) One or more Bid Responses; (3) Downloading and viewing of the Ad Unit on the User's mobile Device; (4) Clicks and/or views of the Ad Unit and the Landing Page; and (5) Any secondary actions performed by User on viewing of the Landing Page (e.g. Click-to-call, Click-for-directions, Social media follows/likes, redemption of Offers, etc.). The advertising target request generates a landing page response 115. In particular embodiments, the mobile device 110 generates an advertising request that is received by the Content Delivery Network/Transparent Caching Subsystem 120. In some embodiments, the advertising request generates a response from the Content Delivery Network/Transparent Caching Subsystem 120—thereby generating an ad request/response 116. By having a single integrated system that incorporates and tracks all of this data across all stages of an Ad Unit lifecycle, the system is able to deliver a fully integrated analytics package for each mobile advertising campaign.

In some embodiments, the Performance Analytics Subsystem 185 logs and collects each independent stage of data, using shared unique identifiers through each stage in order to process the high volume of data. This data may be stored in log files, the central Database Server, or offloaded in a streaming or batch fashion to an external parallel processing cluster. Data may be processed to provide aggregate views of performance characteristics over one or more sliding time windows, or be partitioned over other segments of data such as location of user or individual campaign.

In certain embodiments, the Performance Analytics Subsystem 185 links campaigns that have been generated from a Social Media post, which allows the Subsystem to present a direct comparison of performance between the mobile advertising campaigns and the Social Media campaigns to which the campaigns are linked. In certain embodiments, data processed by the Performance Analytics Subsystem 185 is anonymized and used as input to machine learning algorithms to assist in predictive analysis used to improve future campaign performance.

When running an ad campaign, advertisers often define a schedule and list of properties about the potential viewers of the ad that the advertiser wants to reach. The current state of the art involves advance preparation by either hand or via multiple software programs and tools to prepare a list of advertising targeting criteria. As described herein, the disclosed systems eliminate the need to prepare exhaustive lists of advertising criteria.

In certain embodiments, the system comprises permanent storage capabilities to prevent loss of information due to restart of system components. As shown in FIG. 1, the systems disclosed herein can comprise Distributed In-Memory Data Caching Systems 150. The Data Caching 150 provides data to a Database and Data Storage Subsystem 151. The Data Storage Subsystem 151 can be located on a server or multiplicity of servers. The system further comprises a structured Data Search and Spatial Indexing Engine 152. In other embodiments, the system is accessible by multiple networked servers in order to provide for load-balancing of requests beyond a single networked server. In further embodiments, the system isolates the targeting data of one advertiser from the profiles of another advertiser.

Aspects of the systems can be updated in near-real-time with changes distributed amongst numerous servers operating in a bidding engine capacity. The systems disclosed herein are also searchable and data can be retrieved in shortest amount of time possible, and all results returned within a fixed window (typically less than 100 ms).

In some embodiments, the systems use a layered database and search index techniques and system components in order to meet the stringent requirements of providing data for the RTB Engine 140. In some embodiments, data saved by the Audience Analysis Engine is broken into a one or more Targeting Profiles, each of which can contain one or more Geo Target data structures that are processed by the Geotargeting Subsystems 165 (FIG. 1). The Geo Target 165 data structure may contain a textual encoding of standardized location data such as a zip code, and can also contain a spatial representation such as a centroid latitude/longitude point and radius distance, or other geometric representation.

Targeting Profile data structures are mapped via an Object-Relational-database Mapping (ORM) system to a tabular form, wherein each profile is assigned a Primary Key identifier, and fields of information in the Targeting Profile are mapped to columns in the table. Each Targeting Profile object is inserted, via the ORM system, into a Relational Database Management System (RDBMS). Geo Target objects associated with each Targeting Profile are similarly mapped to a tabular structure via the ORM system, and inserted with Foreign Key references to the Targeting Profile. The RDBMS may be configured to apply additional query optimization techniques such as multiple-column Index creation at the table level. Targeting Profile objects may contain additional Foreign Key references to other Advertiser, Insertion Order, or Campaign level data appropriate to fully specify the information required to deliver ads to the specification of the advertiser.

Immediately following the insertion of the Targeting Profile object into the database, the Geo Target data is processed and stored in a secondary search-index system utilizing the Structural Data Search & Spatial Indexing Engine 152. The search-index system will perform an analysis on each of the fields in the Geo Target structure, and select a suitable indexing algorithm for each data type. String or token fields, such as zip code, may be stored in one or more indices using compression algorithms to limit the size of the index. Hashing techniques may be used on each token to enable optimal search times through the index based upon mathematical probability. Spatial representation fields may be stored in the index using either a numeric index suitable for double-range queries, or by using a quad-tree representation where coordinates are encoded in several fields representing different zoom levels. The use of one or both of these spatial representations may be selected based upon performance and/or density of coordinates stored in the index.

Additionally, the Storage System may perform additional pre-fetching and building of data structures such as Zip-Code to Lat/Long geocoded databases, and store these data structures in a similar index to the Targeting Profile geospatial and token search indices. These additional data structures enable the RTB Engine to perform low latency decisions by searching over a smaller data set, as described below.

### 2. Methods for Eliminating No-Bid Requests

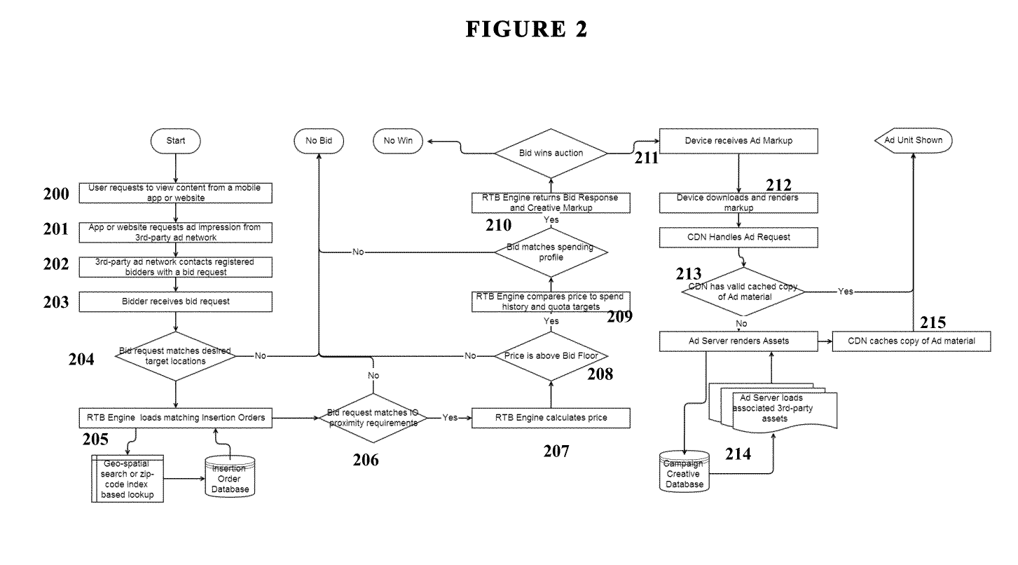

The disclosed systems employ the use of a first-pass filter and decision tree based upon the location data encoded in the Bid Request (FIG. 2). The location data may originate from Device hardware (GPS, WiFi, etc.), user registration data, or IP address to location mapping techniques. The RTB Engine will extract the location information from the request, and compare it to a list of locations internally stored that represent areas referenced by one or more Targeting Profiles in the system. In some embodiments, the RTB Engine may internally convert a string based Geohash or Zip Code to a Lat/Long coordinate, or vice versa, through processes known as geocoding/reverse geocoding, respectively. If no Targeting Profiles reference the location specified by the Bid Request, the RTB Engine will immediately return a No-Bid Response and stop processing other data in the request. The original Bid Request may be stored in a database or similar storage system to be used as an input in future predictive data calculations.

### 3. Method of Determining Positive Bid Responses

Disclosed herein are methods of generating and delivering real-time advertising content to one or more mobile devices. An exemplary method of delivering content is shown in FIG. 2 as a decision tree. Once the RTB Engine has determined that there exists one or more Advertisers with a Targeting Profile registered with the system matching the location or other attributes of the Bid Request, it determines whether or not to participate in the auction for the Ad Unit Impression. The system tracks the desired quantity and budget for participating in auctions through the use of an Insertion Order data structure, which is stored in the shared central Database. Such databases are stored on computers or servers within the system.

The Insertion Order is updated each time a Bid is won by the RTB Engine with a tally of Bids won over multiple time windows, including total spend-to-date for the Insertion Order, spend on the current calendar day, and spend so far during the current month. The third party Ad Network notifies the RTB Engine of a winning bid through a request made via the RTB Protocol in use, along with the final price at which the Ad Unit Impression auction settled. Shared globally unique identifies are passed in the Bid Response, and are used to correlate a Bid Request with a winning Bid, and thus update the Insertion Order appropriately.

### 4. Method of Calculating Ideal Price of Bid

As the Bidder is participating in 1st-price or 2nd-price auctions with an unknown number of other Bidders participating in the auction, the system through the RTB Engine calculates a price that the Bidder is willing to pay to purchase the Ad Unit Impression from a given auction (FIG. 2). The disclosed systems comprise code to determine: (1) the minimum floor for a Bid Request, if any, and (2) the distance from the location of the mobile Device relative to the Advertiser's registered location(s). In some embodiments, the disclosed systems further comprise code that allows the requested number of impressions to serve for a given Advertiser on the current day and the spent budget for the day, the month, and/or the year. In certain embodiments, the disclosed systems comprise code that determines the time remaining in the day. The systems disclosed herein can further comprise code that allows the systems to track the desired number of impressions and budget for the current month.

The disclosed systems can also comprise code that determines whether there are any complementary or makeup impressions associated with an Insertion Order, for which the cost is applied to a House Account. As used herein, the “House Account” refers to a special accounting and billing designation that tells the system to not apply charges for won bids to the Advertiser's account. In some embodiments, the systems comprise code that predicts ideal time of day to deliver ads and expected future availability of ads based on historical precedent of Bid Requests. In particular embodiments, the systems comprise code for estimating the ideal cost based on past Bid Response Win Rate. In other embodiments, the systems comprise code to target resale price or markup pricing on Ad Unit Impressions bought on behalf of Advertiser. In certain embodiments, the systems comprise code to identify other first or third party data contained in the Bid Request identifying a desirable characteristic of the Ad Unit Impression, such as Site ID, User Demographics, or Device attributes.

The disclosed systems also comprise code to determine the proper bid price. In some embodiments, the RTB Engine bids with a higher price when there is a larger quota of Impressions to fill for a given Insertion Order. In some embodiments, the RTB Engine will automatically bid aggressively when there is a larger quota of Impressions to fill for a given Insertion Order. As the quota for requested impressions for a given day or month is neared, the RTB Engine will employ an exponential backoff or similar style algorithm to reduce the Bid Response price, while still maintaining the ability to win auctions when low priced Ad Unit Impressions are available. In this manner, the system may Bid and win more Ad Unit Impression Auctions than would be determined with a simple linear progression model.

In certain embodiments, the system employs Day-parting techniques to even out the spread of Ad Unit Impressions delivered over the course of the day. As used herein, “Day-parting” refers to the use of a repeatable scheduling that informs the system to only bid/deliver ad units for a campaign during certain windows of time during the day. These Day-parting techniques may be based on a combination of fixed algorithmic time-windowing, implicitly developed statistical models based on past performance and expected volume and/or user response rates, or explicitly defined windows of time to bid in auctions specified by the Advertiser.

### 5. Method of Prioritizing Bids for Optimal Proximity

Referring to FIG. 2, when a request for a bid enters the system from the third party ad networks, it may match one or more targeting profiles for advertisers registered with the system. By assigning a scoring system or monetary value based partially on the distance from the advertisers specified location(s), the RTB Engine is able to calculate the expected value of a winning bid based upon algorithms that predict statistically higher user engagement rates when the Ad Unit Impression is for an advertiser with a store, event, or other type landmark or physical location that is in closer proximity to the user.

In the event that a plurality of advertisers have specified overlapping areas of interest in Targeting Profiles, the proximity of each advertiser's desired location to the device or user location in the Bid Request will be used as a partial determining factor in weighting Bid Responses sent on behalf of each advertiser. In some embodiments, the RTB Engine may choose one advertiser or another based upon the proximity of Bid Request to Advertiser, or based upon independently determined Bid price. In other embodiments, the RTB Engine may return multiple Bid Responses, and allow both Advertisers to participate against each other in the third-party Ad Network's auction.

### 6. Method of Dynamically Determining Creative Assets Associated with a Bid Response

Referring to FIG. 2, when a Bid Request is won by the RTB Engine, markup data (typically in the form of HTML and/or Javascript markup) is returned to the third-party Ad Network, and from there to the App or Site Publisher, in order to render the Ad Unit to the user. With its real-time creative rendering systems, the RTB Engine is able to dynamically select a different Ad Unit Creative response for any given Bid Response.

By having the RTB Engine integrated with the other components of the system, this enables a level of dynamic responsiveness not seen in contemporary Advertising Serving systems, where the current norm is to have an Administrative Operations person manually upload new creative materials whenever the Advertiser wishes to change their advertising message.

### 7. Methods of Delivering and Transparently Caching Rendered Ad Units

The disclosed systems leverage the use of a transparent Content Delivery Network (CDN) front-end replicating HTTP Cache with global data center distribution (FIG. 2). This CDN Cache is referenced in the markup returned in the Bid Response with a unique URL specifying which asset is to be downloaded by the mobile Device. When the mobile Device requests the Ad Unit from the CDN, the CDN will look at its internal cache structures to determine if the requested material has already been loaded. If the material has been loaded by the CDN, and has not exceeded a specified Time To Live, it is delivered directly to the mobile Device. If the CDN does not have a current copy of the requested material, it will transparently deliver the request to the Ad Server Subsystem, at which point the material will be dynamically rendered and delivered back to the CDN. The CDN will store this material, and may additionally replicate it to various data centers located across the globe, while simultaneously delivering the requested content back to the device.

In order to minimize network transmission time, when a mobile Device requests material from the CDN, the system may automatically choose a data center that is in a region closest to the physical location of the Device.

### 8. Methods of Dynamic Landing Page Generation and Serving Subsystem

In addition to the graphic of rich media rendering, content linked to the advertising campaign must be delivered to a user device when the user initiates interaction via a click or tap on the Ad. In some embodiments, this content is attached to the ad via a URL designating that the device should employ the use of a Web Browser or WebView component to download and display the content, referred to as a Landing Page. In certain embodiments, the Landing Page is coupled with the Ad Unit Creative, and is generated on-the-fly for each time the user clicks on the Ad Unit.

In other embodiments, the Landing Page Generation and Serving Subsystem is able to generate a complete marketing presence for the Advertiser with no additional effort or customization, by leveraging the same technologies and 3rd-party data APIs, shown in FIG. 1, 199 from the Asset Aggregation Subsystem.

By generating the Landing Page on demand, as opposed to delivering a statically generated set of HTML files or using an external Content Management System, the platform is able to integrate data from the Bid Request, selected Ad Campaign, and Third Party Social Media or other external data sources into the content of the Landing Page.

In some embodiments, Landing Pages generated by the system are delivered in HTML5/CSS3, and leverage a technique known as Responsive Design, to allow the Landing Page to scale and adapt correctly to different size mobile device screen sizes.

### 9. System for Real-Time Geospatial Mobile Advertising Performance Visualization

The system of components and general network architecture described above, by having a tightly integrated single data model that is updated in real-time across multiple servers and coordinated subsystems, allows the system to present real-time views into the performance.

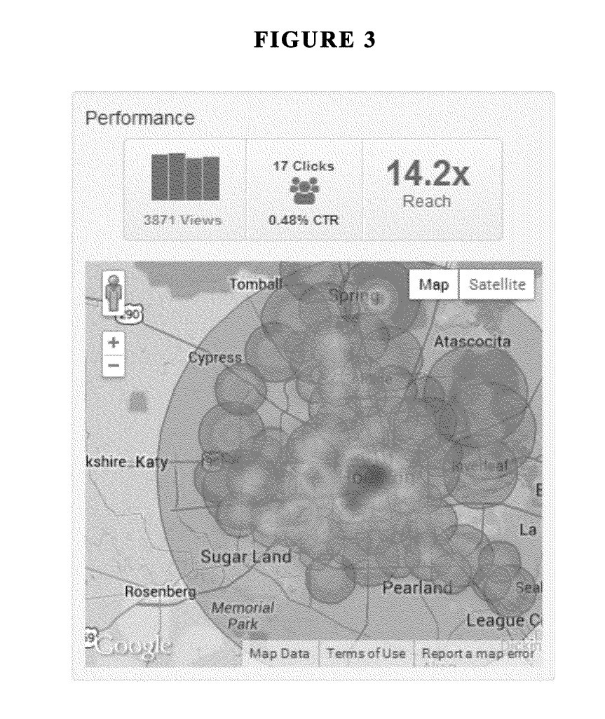

By leveraging the same Data Cache, Data-Grid, geospatial index and search, and performance analytics techniques described above, the system can present to the user a dynamically generated map based view of the density of Ad Unit Impressions delivered, overlaid with a visual representation of the Targeting Profile areas defined by an Advertiser. In some embodiments, this visual display is represented as a Heat-map style visualization of RTB data (FIG. 3).

Because data is available to the integrated Advertiser User Interface in real-time, this view can show up-to-the minute results of where ads are running, and at what density. These views can also be rendered and animated over a sliding time window to provide a clear view of how performance is occurring over time.

Additionally, the system can provide such aggregated real-time views of RTB Engine performance, including supply and density of available Bid Requests, Bid Responses, and Bid Wins, as well as Landing Page Views or Secondary Actions, across one or all Advertiser campaigns.

### 10. Insertion Order Management Subsystem

As shown in FIG. 1, the Insertion Order Management Subsystem 143 is a system component responsible for coordination of Insertion Orders for Ad Unit purchases requested by or on behalf of Advertisers. In certain embodiments, the Insertion Order Management Subsystem 143 directly receives and processes Insertion Orders through a Self-Service User Interface that Advertisers interact with directly. In other embodiments, the Insertion Order Management Subsystem 143 receives and processes Orders from an Administrative User through a separate User Interface, with requests for Insertion Orders handled on behalf of the Advertiser by Administrative Users. In still further embodiments, the Insertion Order Management Subsystem 143 receives requests for Insertion Orders from a third-party application, via an exposed Application Programming Interface (API). The workflow process for of tracking an Insertion Order from initial request through its full lifecycle may be handled entirely automatically by the Insertion Order Management Subsystem 143, or in some cases with intervention by an Administrative User.

An Insertion Order request may contain or specify references to all information required to create and activate an Advertiser's campaign, including Targeting Profile, Creative Specification, and other required data such as Billing information.

As part of the Insertion Order Management Subsystem, the system may comprise one or more integrations with third-party billing providers. This systems integration enables the direct billing of Advertisers via Credit Card or other payment method. On a periodic basis, the Insertion Order Management Subsystem may calculate costs for Ad Unit Impressions served by the system to date, and process an Invoice or other request for payment. In one embodiment of the system, Insertion Orders are created with a fixed number of impressions which are billed at a fixed price. In further embodiments, Insertion Orders are created with a fixed budget. In other embodiments, the Insertion Orders are created with a variable pricing based upon a markup after the cost of Impressions won at the time of auction by the RTB Engine.

One advantage of the fully integrated Insertion Order Management Subsystem is that the subsystem enables a Self-Service portal wherein Advertisers are individually able to request create and request advertising campaigns without the intervention of an Administrative User or account representative. A further advantage of the integrated Insertion Order Management Subsystem as described herein, is the enablement of innovative pricing models, such as a Pay-as-you-go pricing model or a Subscription Media model, where prices are calculated based on the outcomes of each individual RTB Engine bid request/win.

### 11. Description of Illustrative Embodiment

FIG. 2 is an illustrative embodiment of a method in which the system renders advertising content. Prior to the system obtaining a bid request, a user requests to view content 200 from a mobile device through an app or a website. The app or website comprises instructions to request advertising content from a third-party advertising network 201. The third-party network sends a bid request to registered bidders 202.

The bid request is received by the system 203. The system determines whether a bid request matches desired target locations 204. The system checks for location information such as geo-spatial, zip code, Geohash, and other information location in an indexed database 205. If the bid request does not match the target location, then there is no bid. The system checks to determine whether the location of the mobile device matches the proximity requirements set forth by one or more advertisements 206. If the bid request does not match the proximity requirements, then there is no bid.

If a bid request matches the desired target location and proximity requirements, then the bid request is sent to the real-time bidding engine to calculate the price of the bid 207. The system determines whether the bid price is above the bid floor 208. If it is not, then there is no bid. If it is, then the real-time bidding engine compares price to a spend history and quota targets stored in at least one database 209. If the bid matches the spending profile of an advertisement, then the real-time bidding engine returns a bid and creative markup content generated by the system 210.

If the bid wins an auction, then the mobile device receives the advertising markup 211. When the mobile device renders the markup 212, the system determines whether it has a valid cached copy of advertising content 213. If it does not, then the advertising server provides assets to a campaign creative database and such content is sent to an advertising server to load assets 214. The system caches copy of advertising content and provides the content to the mobile device 215.

We claim:

1. A system for the automatic creation and targeting of real-time advertising content comprising:
a) at least one server comprising a processor and one or more computer-readable mediums, wherein the one or more computer-readable mediums store information selected from the group consisting of data, instructions executable by the processor, and combinations thereof;
b) a transparent caching system that stores advertising content and to deliver advertising content created by the system to one or more devices on a network;
c) a real-time bidding subsystem that processes one or more bid requests from a third-party network;
d) an asset aggregation and creative generation subsystem that converts the one or more bid requests into advertising content responsive to each of the one or more bid requests;
e) an advertising serving subsystem that retrieves advertising content from one or more databases, wherein the advertising serving subsystem comprises an advertising rendering subsystem that generates advertising content in response to one or more bid requests and delivers the advertising content to a mobile device;
f) a geospatial subsystem that calculates a first location of the one or more devices accessing a mobile website or application; and
g) instructions for matching the location of one or more users to a second location of one or more advertising campaigns.

2. The system of claim 1, further comprising an audience analysis subsystem that stores profiles relating to subscribers on social media networks.

3. The system of claim 2, wherein the audience analysis subsystem creates a targeting profile based on geographic and demographic data relating to the customers of one or more advertisers extracted from social media networks and other third-party data collection systems.

4. The system of claim 1, further comprising a geospatial subsystem that stores the locations of one or more devices on the network.

5. The system of claim 3, wherein the audience analysis subsystem calculates a probability of a matching bid request in a particular location of an advertiser.

6. The system of claim 1, further comprising a campaign optimization subsystem to monitor the performance of advertising content delivery.

7. The system of claim 1, wherein the campaign optimization subsystem calculates the future performance of advertising content based on past performance of content delivered by the system and past performance of advertising content delivered by third-party networks.

8. The system of claim 1, wherein the asset aggregation and creative generation subsystem comprises instructions executable by the processor to aggregate creative content from one or more online sites.

9. The system of claim 8, wherein the system stores the aggregated creative content in one or more databases.

10. The system of claim 1, wherein the advertising rendering subsystem selects graphics, color palettes, backgrounds, text, or other graphical information from one or more databases.

11. The system of claim 10, wherein the asset aggregation subsystem comprises instructions executable by the processor to aggregate and store graphics, color palettes, backgrounds, text, or other graphical information from online sites and available third-party content.

12. The system of claim 1, further comprising a performance analytics subsystem that stores data relating to the processing of each bid request.

13. The system of claim 1, wherein the system comprises a layered database and search index architecture.

14. The system of claim 1, wherein the system creates one or more profiles based on data stored by the audience analysis engine in one or more databases.

15. The system of claim 1, further comprising an object-relational-database mapping system.

16. The system of claim 1, wherein the system comprises permanent storage.

17. The system of claim 16, wherein the permanent storage comprises one or more data caching systems accessible by the at least one server.

18. The system of claim 1, wherein the real-time bidding subsystem comprises instructions executable by the processor to determine whether one or more advertisers having a profile in the system match a location or attribute of one or more bid requests.

19. The system of claim 1, wherein the system comprises instructions executable by the processor to track a budget required to participate in an auction.

20. The system of claim 1, wherein the system comprises instructions executable by the processor to tally a number of bids won over multiple pre-defined windows of time.

21. The system of claim 1, wherein the real-time bidding subsystem comprises instructions executable by the processor to receive notification from one or more advertising networks that a bid was won.

22. The system of claim 1, wherein the real-time bidding subsystem comprises instructions executable by the processor to calculate a price that a bidder will pay to purchase the advertising content.

23. The system of claim 1, wherein the system comprises instructions executable by the processor to deliver the generated content to one or more devices on a network.

24. The system of claim 1, wherein the system comprises instructions executable by the processor to receive a direct real-time advertising request from a publisher.

25. The system of claim 1, wherein the system comprises instructions executable by the processor to render web-based content, wherein the instructions comprise a content rendering layout engine.

26. The system of claim 1, further comprising instructions executable by the processor to identify data of a first or a third party associated with the bid request to identify a characteristic of the advertising content desired by an advertiser.

27. The system of claim 1, wherein the system comprises instructions executable by the processor to deliver advertising content during certain periods during a day.

28. The system of claim 1, wherein the real-time bidding subsystem comprises instructions executable by the processor to calculate an expected value of a winning bid.

29. The system of claim 29, wherein the expected value is a prediction of whether there will be higher user engagement rates for advertising content depending on the proximity of an advertiser location to a consumer.

30. The system of claim 1, wherein the system comprises instructions executable by the processor to bid on advertising content during certain periods during a day

31. The system of claim 1, wherein the system comprises a database and instructions to index advertising data stored in the database.

32. The system of claim 1, wherein the system comprises one or more data storage subsystems.

33. The system of claim 1, wherein the system comprises instructions executable by the processor to search a database for information selected from the group consisting of geo-spatial information, zip code information, Geohash, and other information relating to a past, present, or predicted future location of a user.

34. The system of claim 1, wherein the system comprises instructions executable by the processor to determine whether a bid request matches a proximity of a consumer to an advertiser or advertising campaign.

35. The system of claim 1, wherein the system comprises instructions executable by the processor to receive a mark-up for content for a third-party.

36. The system of claim 1, wherein the system comprises instructions executable by the processor to generate advertising content based on the mark-up and graphical information stored in one or more databases.

37. The system of claim 1, wherein the system comprises instructions executable by the processor to determine whether a generated advertising content has a cached copy.

38. The system of claim 37, wherein the system comprises instructions executable by the processor to store the generated advertising content in one or more databases.

39. The system of claim 37, wherein the system comprises instructions executable by the processor to provide the generated advertising content to the mobile device.

40. The system of claim 1, wherein the system comprises a content rendering engine and an HTML media rendering engine.

41. The system of claim 1, wherein the advertisement is specific for a mobile device located at a particular zip code or geo-spatial location.

42. The system of claim 1, further comprising a landing page generation and serving subsystem that generates a marketing presence for an advertiser.

43. The system of claim 42, wherein the landing page generation and serving subsystem comprises instructions executable by the processor to generate advertising content and deliver the content in response to identifying an access of a web-based advertisement by a user of the mobile device.

44. The system of claim 43, wherein the landing page generation and serving subsystem comprises instructions executable by the processor to generate a landing page in response to the user accessing a web-based advertisement.

45. The system of claim 43, wherein the landing page generation and serving subsystem comprises instructions executable by the processor to scale the content to the size requirements of the mobile device.

46. The system of claim 1, further comprising instructions executable by the processor to generate a dynamic map of the density of advertising content delivered in a location.

47. The system of claim 46, wherein the system comprises instructions executable by the processor to update the map every minute.

48. The system of claim 1, further comprising an insertion order management subsystem that coordinates one or more insertion orders for an advertiser.

49. The system of claim 48, wherein the insertion order management subsystem comprises instructions executable by the processor to receive one or more insertion orders through an interface.

50. The system of claim 48, wherein the insertion order management subsystem comprises instructions executable by the processor to process one or more insertion orders.

51. The system of claim 48, wherein the insertion order management subsystem comprises instructions executable by the processor to receive one or more insertion orders from a third-party application through an application programming interface.

52. The system of claim 48, wherein the insertion order management subsystem comprises instructions executable by the processor to process billing information relating to an advertiser.

53. The system of claim 48, wherein the insertion order comprises information selected from the group consisting of targeting profile, specifications for the type of advertising content to be delivered, and data relating to billing.

54. The system of claim 1, wherein each subsystem is stored on one or more computer-readable mediums.

55. A method for the automatic creation and targeting of real-time advertising, the method comprising:
a) providing at least one server comprising a processor and a computer-readable medium, wherein the computer-readable medium stores information selected from the group consisting of data, instructions executable by the processor, and combinations thereof;
b) the processor executes the instructions stored in the computer-readable medium to perform the steps of:
i) receiving a bid request from a third-party network;
ii) calculating a location for one or more devices on the network;
iii) matching the bid request to an advertiser profile stored in a database, wherein the advertiser profile comprises a target location for the advertiser;
iii) tracking a bid price for a content by accessing a database on the at least one server, the database indexing information relating to the bid price;
iv) calculating the bid price to be presented to an auction;
iv) downloading a mark-up content from a database indexing the content; and
v) rendering the content to an advertiser network or a site publisher.

56. The method of claim 55, wherein the processor executes instructions for comparing the location of the mobile device to the target location of the advertiser.

57. The method of claim 56, wherein the location of the mobile device is determined by analyzing data selected from the group consisting of data originating from a mobile device, previously cataloged Geohash or geospatial recorded history, consumer registration data, and IP address mapping.

58. The method of claim 55, wherein the location is extracted from a bid request and compared to target locations stored in one or more databases.

59. The method of claim 55, wherein the processor executes instructions for bidding for an advertisement.

60. The method of claim 59, wherein the processor executes instructions for receiving notification from the auction that a bid was successful.

61. The method of claim 55, wherein the processor executes instructions for determining the distance from the location of the device to the target location.

62. The method of claim 55, wherein the processor executes instructions for tracking a budget allocated by the advertiser for a given month.

63. The method of claim 55, wherein the processor executes instructions for predicting an appropriate time of day to deliver advertisements to the device or a third party.

64. The method of claim 55, wherein the processor executes instructions for predicting a proper bid based on a calculated bid response win rate.

65. The method of claim 55, wherein the processor executes instructions for calculating the expected value of a winning bid based upon distance between the third party and the advertiser.

66. The method of claim 65, wherein the calculation takes into account stored information regarding the advertiser selected from the group consisting of store location and location of events.

67. The method of claim 55, wherein the processor executes instructions for weighting the advertiser as against other advertisers stored in the system based on proximity of the advertiser to the device or a third party.

68. The method of claim 55, wherein the processor executes instructions for receiving a request from a mobile device for the content.

69. The method of claim 68, wherein the processor executes instructions for accessing cache upon the request from the mobile device to determine whether the requested content has been previously loaded in the cache.

70. The method of claim 69, wherein the processor executes instructions for delivering the request to an advertiser server subsystem for rendering and delivering of the requested content.

71. The method of claim 55, wherein the content further comprises information accessible to the user when the content is accessed on the device.

72. The method of claim 55, further comprising storing one or more profiles relating to one or more subscribers on social media networks.

73. The method of claim 72, wherein the profiles are based on geographic and demographic data relating to the customers of one or more advertisers extracted from social media networks and other third-party data collection systems.

74. The method of claim 55, further comprising storing information relating to the locations of one or more devices on the network.

75. The method of claim 55, further comprising calculating a probability of a matching bid request in a particular location to an advertiser.

76. The method of claim 55, further comprising monitoring the performance of advertising content delivery.

77. The method of claim 55, further comprising calculating a future performance of advertising content based on past performance of content delivered by the system and past performance of advertising content delivered by third-party networks.

78. The method of claim 55, wherein the system comprises instructions executable by the processor to aggregate creative content from one or more online sites.

79. The method of claim 79, further comprising storing the aggregated creative content in one or more databases.

80. The method of claim 55, storing graphics, color palettes, backgrounds, text, or other graphical information in one or more databases for generation of advertising content.

81. The method of claim 80, aggregating graphics, color palettes, backgrounds, text, or other graphical information from online sites and available third-party content.

82. The method of claim 55, further comprising storing data relating to processing of each bid request.

83. The method of claim 55, further comprising creating one or more profiles based on data stored in one or more databases.

84. The method of claim 55, further comprising determining whether one or more advertisers having a profile in the system match a location or attribute of a bid request.

85. The method of claim 55, further comprising tracking the budget required to participate in the auction.

86. The method of claim 55, further comprising counting a number of bids won over multiple pre-defined windows of time.

87. The method of claim 55 further comprising receiving notification from one or more advertising networks that a bid was won.

88. The method of claim 55, further comprising calculating a price that a bidder will pay to purchase the advertising content.

89. The method of claim 55, further comprising delivering content to one or more devices on a network.

90. The method of claim 55, further comprising receiving a direct real-time advertising request from a publisher.

91. The method of claim 55, further comprising identifying data of a first or a third party associated with the bid request to identify a characteristic of the advertising content desired by an advertiser.

92. The method of claim 55, further comprising delivering advertising content during certain periods during a day.

93. The method of claim 55, further comprising calculating the expected value of a winning bid.

94. The method of claim 93, wherein the expected value is a prediction of whether there will be higher user engagement rates for advertising content depending on the proximity of an advertiser location to a consumer.

95. The method of claim 55, further comprising bidding on advertising content during certain periods during a day

96. The method of claim 55, wherein data is stored on a database and instructions to index advertising data.

97. The method of claim 55, wherein data is stored on one or more data storage subsystems.

98. The method of claim 55, further comprising searching a database for information selected from the group consisting of geo-spatial information, zip code information, and other information relating to the location of a user.

99. The method of claim 55, further comprising determining whether a bid request matches a proximity of a consumer to an advertiser.

100. The method of claim 55, receiving a mark-up for content for a third-party.

101. The method of claim 100, further comprising generating advertising content based on the mark-up and graphical information stored in one or more databases.

102. The method of claim 55, further comprising determining whether a generated advertising content has a cached copy.

103. The method of claim 102, further comprising storing the generated advertising content in one or more databases.

104. The method of claim 55, further comprising providing the generated advertising content to the mobile device.

105. The method of claim 55, wherein the advertisement is specific for a third-party located at a particular zip code or geo-spatial location.

106. The method of claim 55 further comprising generating a complete marketing presence for an advertiser.

107. The method of claim 106, generating advertising content and delivering the content in response to identifying an access of a web-based advertisement by a user of a mobile device.

108. The method of claim 106, further comprising generating a landing page in response to a user accessing a web-based advertisement.

109. The method of claim 106, further comprising scaling the content to the size requirements of the mobile device.

110. The method of claim 55, further comprising generating a dynamic map of the density of advertising content delivered in a location.

111. The method of claim 110, further comprising updating the map every minute.

112. The method of claim 55, further comprising coordinating one or more insertion orders for an advertiser.

113. The method of claim 112, further comprising receiving one or more insertion orders through an interface.

114. The method of claim 112, further comprising processing insertion orders.

115. The method of claim 112, further comprising receiving one or more insertion orders from a third-party application through an application programming interface.

116. The method of claim 112, further comprising processing billing information relating to an advertiser.

117. The method of claim 112, wherein the one or more insertion orders comprise information selected from the group consisting of targeting profile, specifications for the type of advertising content to be delivered, and data relating to billing.
